(19) United States
(12) Patent Application Publication
(10) Pub. No.: US 2005/0218575 A1
(43) Pub. Date: Oct. 6, 2005

(54) Vacuum workholding fixture

(76) Inventors: Larry Cook, Woodinville, WA (US); Bob Samack, Woodinville, WA (US)

Correspondence Address: DELLETT AND WALTERS, P. O. BOX 2786, PORTLAND, OR, 97208-2786, US

(21) Appl. No.: 10/997,758

(22) Filed: Nov. 24, 2004

Related U.S. Application Data
(60) Provisional application No. 60/525,234, filed on Nov. 24, 2003.

(51) Int. Cl. B25B 11/00

(52) U.S. Cl. 269/21

(57) ABSTRACT

A vacuum workholding system employs vacuum disks and enables modular flexibility in setting up work pieces, such as wing skins, for machining.

### CROSS REFERENCE TO RELATED APPLICATIONS

This application claims priority from U.S. provisional patent application 60/525,234, filed Nov. 24, 2003.

### BACKGROUND OF THE INVENTION

This invention relates to a modular concept that allows for flexibility in setting up a wing skin for machining. This has the ability to be adjusted to handle a vast number of parts on the same tooling bed. This is accomplished by a vacuum disk end-effector, a pop up pin using a disk design for mounting the indexing tools as well.

The invention employs a clamping device, named a “Clamp Hog” by applicants, for securing the edge of the metal being machined and allow for the crane to flip the part over 180 degrees and not scratch or mar the surface of the fixture.

The system provides the ability to adjust the pattern arrangement of the vacuum disks to provide coverage to the edge of the part. These parts have angled cuts along the 30′-80′ length on both sides and these dimensions are variable for each part. The system also provides the ability to provide a change in vacuum point centers from 8 inches to 2 inches.

The workholding fixture has the ability to have variable zones of vacuum set up without having to machine new grooves for sealing off zones in the fixture.

The fixture has a pocket type design across the table and does not require any fastening bolts or pins to secure our vacuum disks, pop up pins, indexing or part reference measurement devices.

The seal groove design on the fixture and disk work together.

The system further has the ability to bring into play selected “Z” dimension changes with the disk design and clamping arrangement, and allows for cutter clearance to protect the fixture face.

The system also has both air and vacuum capability through each disk unit.

A quick disconnect feature is provided for changing out disks and for disk rotation to position at edge of part for hold down.

Software of the system has the features to measure vacuum performance at each disk and also a feature to confirm that part is down and secured with vacuum at any disk location and between disks.

Applicants also measure the amount of vacuum in force at each disk and inform if any notable drop is to occur.

A tool that is used to make disk adjustments that keeps the operator from having to bend over to clock the rotation of the desk to set the vacuum points in a proper position is provided in accordance with the invention.

The applicants' system is very different from the conventional vacuum type chucking tools used to perform a vacuum holding process for machining.

### BRIEF DESCRIPTION OF THE DRAWINGS

FIG. 1 is a view of a lift insert assembly in the retracted and extended positions;

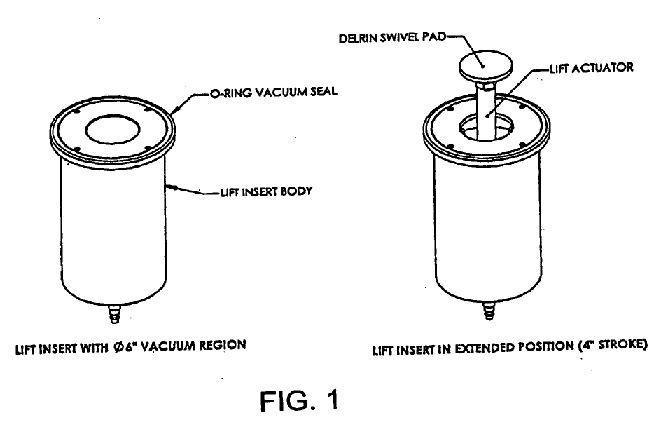

FIG. 2 is a view of a 2 inch by 3 inch insert assembly;

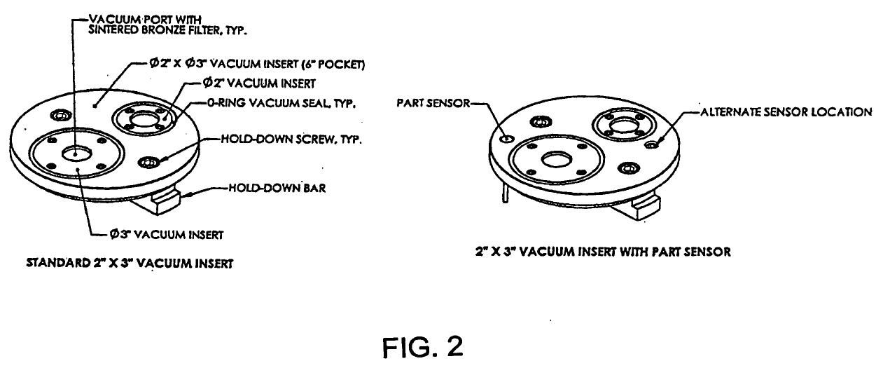

FIG. 3 is a view of a 6 inch insert assembly;

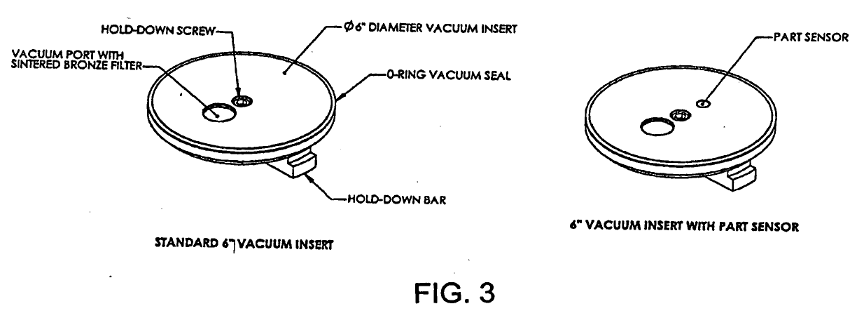

FIG. 4 is a top view of a vacuum chuck assembly;

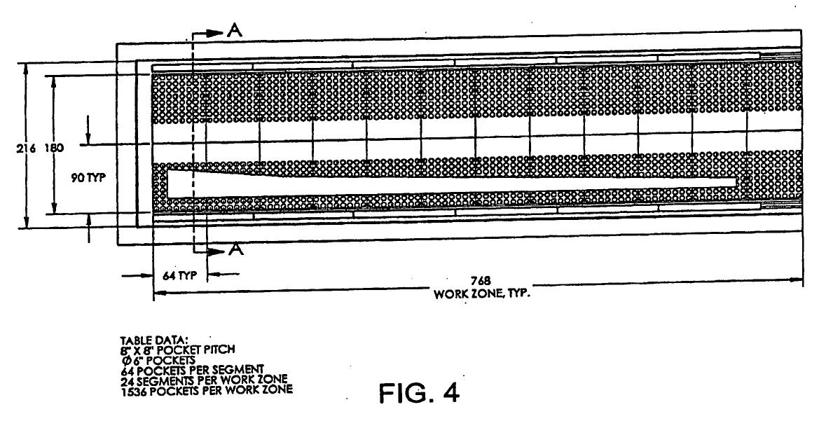

FIG. 5 is a sectional view of the vacuum chuck assembly taken along line A-A of FIG. 4; and

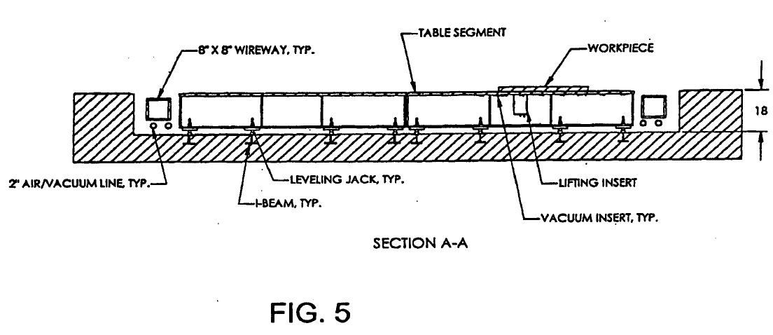

FIG. 6 is a perspective view of the vacuum chuck assembly of FIG. 4.

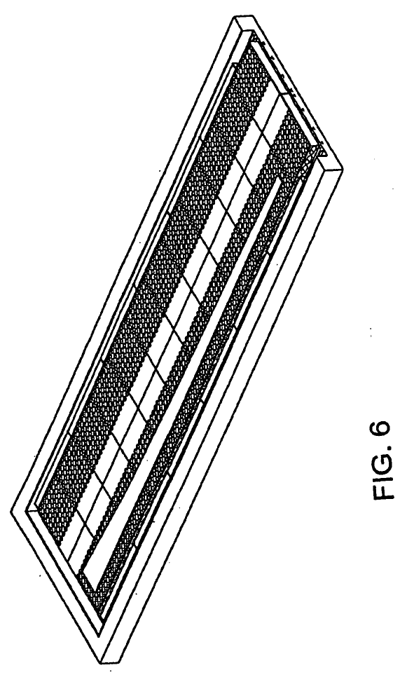

### DETAILED DESCRIPTION

The system according to a preferred embodiment of the present invention comprises workholding fixtures which may comprise 2 and 4 work zones, to accommodate for example, five (5) part numbers and their opposite hands, through the use of programmable zonal vacuum.

Each workholding zone in a preferred embodiment will accommodate two (2) opposite hand parts, fixtured side by side as parts are produced as a ship set throughout the skin manufacturing process. A four (4) work zone configuration has a capacity and size to meet the maximum part envelope measurement of five (5) feet (60 inches) wide and 160 feet (1,920 inches) long. The 2 work zone table is 120 feet (1,440 inches) in a preferred embodiment.

The workholding fixture is designed and built to handle four (4) parts weighing as a raw distributed load at 2,000 lbs. The workholding fixture is built and installed in the X axis work surface to a flatness of 0.0004 inches per foot and 0.003 inches TIR for the full length of the workholding table surface.

To assist in the process of chip collection the vacuum cup component parts and other lifting and positioning devices are flush and “chip tight” at the work level of the workholding table surface. A “highlight” color effect can be provided to define chip partials laying on the surface of the table and/or the associated hardware. This will help to identify foreign objects on the table surface.

The current part holding art has operational deficiencies that need to be improved upon or eliminated as follows:

1. Reduce setup times. Currently 3 5 hours.

The setup time in accordance with the invention is reduced through the use of a tested and proven technology developed by CNA Manufacturing Systems, Inc., Woodinville, Wash. US, in the operation of its flexible tooling products. A modified end effector design that is incorporated into the workholding table surface is provided, called a vacuum disk.

Applicants have established within each of the four (4) work zones 768 vacuum disks for a total of 3,072. Each is independently operated to be set up as required to bring the entire surface area of the part against the Workholding table surface. Each unit also has the ability to create an air cushion surface for parts to ride on. Each vacuum disk has sensors to monitor the level of vacuum efficiency and provide audio and graphic displays to the machine operator during the setup and machining cycles.

The system provides a secondary level of proper part position against the workholding table surface, at a vacuum disk grouping of four (4) to one (1) secondary measurement disks by equipping the zone with a part reference sensor to detect the part being down against the workholding surface. This also provides indication of material movement due to any vacuum drop on a constant basis during the machining-process.

The software systems design by CNA for the flexible tooling system provides any number of data points as required to meet tooling and machining operation and setup times. Feedback is through three (3) operational points. The machine tool CNC Controller, the CNA Controllers and the handheld portable computer(s). The system also has the ability to print out written record of tool and part performance during the machine cycle.

The system provides functional solutions to the above referenced operational deficiencies.

Reduced Set Up Time

TABLE 1

| Work Tasks | | Time Range | |
|---|---|---|---|
| 1. | Clean off chips, prep fixture | 5-8 | minutes |
| 2. | Enter part number | | |
| 3. | View vacuum disk layout to part | 1-2 | minutes |
| 4. | View marginal vacuum disk positions | 2-3 | minutes |
| 5. | Change out, adjust disk(s) as required | 8-12 | minutes |
| 6. | View part reference switches/adjust | 4-5 | minutes |
| 7. | View pop-up pin locations/adjust | 3-5 | minutes |
| 8. | Set up Clamp Hogs (see issue 9 below) | 5-7 | minutes |
| 9. | Position crane with edge damps | 3-5 | minutes |
| 10. | Lift part and move across fixture | 2 | minutes |
| 11. | Lower into Clamp Hogs/secure | 5 | minutes |
| 12. | Rotate part flat position/index | 5-7 | minutes |
| 13. | Remove edge clamps/park crane | 2-3 | minutes |
| 14. | Adjust part to index points | 1-2 | minutes |
| 15. | Remove Clamp Hogs/set aside | 2-3 | minutes |
| 16. | Retract pop-up pins | | |
| 17. | Apply vacuum to part/sequence | 10-15 | minutes |
| 18. | Review screens for secured part | 2-4 | minutes |
| 19. | Time to adjust/Roboroller (see issue 8 below) | 8-10 | minutes |
| 20. | Tool controller gives status to start | 68-84 | minutes |
| | machine/truck performance | | |
| | Estimated Set-Up Time | | |

The system reduces need to remove vacuum seals. Reduce need for excessive vacuum seal replacement and adjustments. The system features reduced setup times from 3-5 hours to less than 75 minutes per part configuration. The vacuuming of different parts seals requiring adjustments will no longer be basic operational requirements.

The Vacuum Disk design allows for seals to be simple and robust in design and application. Easy to replace and allows for consistent monitoring of performance when in use and less material and labor cost to remove and replace.

The system incorporates programmable zonal vacuum control. Turning vacuum zones (points) on and off. Matching the vacuum zone to the periphery of the part to be fixtured and machined.

The system software and vacuum disk design provides total programmable zonal vacuum control on variable centers across the entire part workholding area. This allows for the machine operator to match the vacuum zone to the periphery at trim off as well as the interior part areas for final machining.

Part edge pop up support is provided. Independently operated part edge pop up supports are provided for the outboard and inboard edges of all five (5) parts. These are modular in design and can be introduced throughout the workholding fixture.

Vacuum zones holding peripheral scrap during machining. Individual vacuum zones can be created into various shaped zones to hold peripheral scrap material during machining and other areas of the parts.

Has feedback on vacuum zones about individual vacuum levels. The system can have at selected part reference sensors to monitor position of skin while machining takes place.

The system has operator feedback on all vacuum zones as well as individual vacuum points across the workholding fixture. Part reference sensors are used to provide necessary feedback information to the machine tool operator that part remains in contact with the datum surface of the table through all machining cycles to either side of the part.

(Issue 8) The system has the ability to flatten a part that has taken a curl set and cannot be vacuumed down to the fixture to ensure complete vacuum of the part surface.

A robot roller to operate by remote control to flatten parts that have a curl to them and cannot be vacuumed down is also employable. This unit can be used for similar applications on other machining tools.

(Issue 9) The system provides an easy and efficient method to lift a part and flip over without having the edge drag across the workholding table surface.

The system includes CNA Clamp Hogs to provide edge protection of the part edge arid avoid dragging the sharp edge of the part across the workholding table surface when flipping the part over or removing the part from the fixture entirely.

The following is a description of how this workholding fixture functions in conjunction with a crane system.

Description of Operation

The machine tool operator enters a part identity code and the part offset at the CNA controller or his hand held PC. This function will initiate the following sequence of operation:

A visual outline of the untrimmed or trimmed part will appear as it relates to the workholding fixture. The screen shows within the part envelope the status of all Vacuum Disks that are in a proper position and/or orientation to provide vacuum against the part. These will be identified with a green color. The Vacuum Disks that are marginal or straddle the part edge will be identified with a red color. A segment matrix reference system will allow the operator to manually make a change out of any Vacuum Disks required. Any disks not being used are identified with a gray color.

The operator receives a confirming signal and obtains a confirmation that the Vacuum Disks are in a proper position to secure the part down to the surface of the workholding fixture. This is indicated with a screen view of the part outline in black and all Vacuum Disks located within the part edge outline will be green.

Once the operator has all Vacuum Disks in a proper mode to secure the part to the surface of the Workholding Fixture, the operator then pulls up a second screen showing the location of part reference switches used to provide confirmation that the part is vacuumed down against the datum surface of the table. If any adjustments are required the operator will make the appropriate changes. This screen also identifies the pop up pin locations as they relate to the part edges and the spacing between pop up pins along the part length. If any need to be moved or deactivated the operator will again review the screen for instructions and obtain conformation that all pop up pins are in a proper position.

The Clamp Hogs are placed in the designated locations along the inboard part line and positioned in a vertical position to receive the part into the self clamping jaws of the Clamp Hog. Once the part is seated in the Clamp Hog the operator is prepared to rotate the part from a vertical position to a horizontal position on the Workholding Fixture.

The operator makes a run through all the screens to receive confirmation the Workholding Fixture is prepared and ready to receive part. All Vacuum Disks not involved with the part are indicated in gray. These are automatically shutoff by the part envelope program. A light tree at the CNA controller goes from an amber to green color. An embedded light in each Workholding Fixture segment will also change from amber to green to a green from an amber color. The operator will then activate the appropriate pop up pins and all Vacuum Disks to be used to secure the part provide an airflow cushion to assist with part placement.

The operator lifts the part to a vertical position using edge clamps suspended from a spanner bar and crane. The clamped part is raised to clear the cart rack and be moved to the edge of the Workholding Fixture.

The operator brings the vertical suspended part across the bed of the Workholding Fixture to position directly above the Clamp Hogs, The part is then lowered into the jaws of the Clamp Hogs. Once the part is secured, by the Clamp Hogs the operator lowers the part toward the outboard edge of the Workholding Fixture. The part is lowered into a position to engage the index pins and come to rest on the extended pop up pins.

The Workholding Fixture configuration consists of the following primary components for a 4 zone table:

64 5′ wide×7′6″ long×15″ high modular structural weldments fabricated to a work surface flatness of 0.0004 inches per foot and 0.003 inches in TIR for the full length of 160′ bed. Each bed section is machined for selected vacuum point locations and other part positioning and lifting requirements.

3,072 Vacuum Disks with programmable vacuum air and part sensor controls units placed at variable centers.

160 air operated pop up lift

2 Model 2000 POGO Flexible Tooling System Controllers with software, network, and power supply(s) manufactured by CNA Manufacturing Systems, Inc.

40 Edge protection devices

1 5000 lb. robot cart to press down and flatten curled parts, propane powered, radio controlled.

2 vacuum pump systems with receiver tanks, valves/pumps/piping.

The Workholding Fixture configuration for a 2 zone table comprises:

24 5′ wide×120 foot long×15″ high modular structural weldments fabricated to a work surface flatness of 0.0004 inches per foot and 0.003 inches in TIR for the full length of 160′ bed. Each bed section is machined for selected vacuum point locations and other part positioning and lifting requirements.

1536 Vacuum Disks with programmable vacuum air and part sensor controls units placed at variable centers.

80 air operated pop up lift

1 Model 2000 POGO Flexible Tooling System Controllers with software, network, and power supply(s) manufactured by CNA Manufacturing Systems, Inc.

20 Edge protection devices (Clamp Hogs)

1 5000 lb. robot cart to press down and flatten curled parts, propane powered, radio controlled.

1 vacuum pump system with receiver tanks, valves/pumps/piping.

While a preferred embodiment of the present invention has been shown and described, it will be apparent to those skilled in the art that many changes and modifications may be made without departing from the invention in its broader aspects.

1. A vacuum workholding fixture system, for holding a workpiece comprising:
plural work zones employing programmable zonal vacuum,
having plural independently operable vacuum disks.

2. The system according to claim 1, wherein ones of said vacuum disks comprise vacuum level sensors.

3. The system according to claim 1, further comprising audio/graphical display for reporting system operation to an operator.

4. The system according to claim 1, further comprising zonal vacuum control, for adjusting a vacuum zone to match a periphery of the workpiece.
